(19) United States
(12) Patent Application Publication
(10) Pub. No.: US 2015/0028521 A1
(43) Pub. Date: Jan. 29, 2015

(54) APPARATUS AND METHOD FOR MANUFACTURING PRODUCT WITH DECORATIVE PATTERNS

(71) Applicant: BUTTON INTERNATIONAL CO., LTD., Taipei City (TW)

(72) Inventor: Chung Lung CHEN, Taipei City (TW)

(73) Assignee: BUTTON INTERNATIONAL CO., LTD., Taipei City (TW)

(21) Appl. No.: 14/024,060

(22) Filed: Sep. 11, 2013

(30) Foreign Application Priority Data
Jul. 26, 2013 (TW) 102126813

(51) Int. Cl. B29C 45/00

(52) U.S. Cl. CPC B29C 45/0003
USPC 264/266; 425/112

(57) ABSTRACT

An apparatus for manufacturing product with decorative patterns includes a fixed and a movable mold base, and a decorative film. A fixed mold insert is fitted in the fixed mold base and is provided with a sprue and at least one molding cavity.

The movable mold base is movable toward or away from the fixed mold base and includes an ejector pin unit and a movable mold insert, which is provided with at least one material receiving cavity. The decorative film is placed in between the fixed and the movable mold insert to cover the molding cavity and material receiving cavity, and is provided with a material passing opening corresponding to the sprue. A method for manufacturing product with decorative patterns is also disclosed to ensure increased yield rate of injection molded products with varied and precise surface patterns through effective cost control in the manufacturing process.

### FIELD OF THE INVENTION

The present invention relates to an apparatus and method for manufacturing product with decorative patterns, and more particularly, to an apparatus and method for forming molded product with decorative patterns in a mold through one-step injection molding, so as to save time and labor and effectively reduce manufacturing cost while achieving the purposes of automated production and increased yield rate.

### BACKGROUND OF THE INVENTION

According to the conventional technology of in-mold decoration by roller, a printed plastic film wound into a roll is mounted in an injection molding machine and an injection molding mold for attaching to the surfaces of a plurality of injection molded products in a manner similar to labeling. Then, the molded products are removed from the injection molding machine via a full-automatic movable loop belt. This technology is also referred to as in-mold decoration injection molding. That is, patterns are printed onto a roll of PET (polyethylene terephthalate) plastic film, and the printed PET plastic film is fed by a film feeder into a mold, as shown in FIG. 1A, and is then heated and sucked to a cavity in the mold, as shown in FIG. 1B. When a material is injected into the mold cavity, the patterns printed on the PET plastic film are transferred onto the surface of the injection molded product, as shown in FIG. 1C. Finally, the molded product with the PET plastic film attached thereto is removed from the mold cavity, as shown in FIG. 1D, and the plastic film is peeled off from the molded product to obtain a finished product having printed patterns shown on the surface thereof.

The conventional technology of in-mold decoration by roller as described above is disadvantageous because the printed patterns transferred onto the surface of the molded product is an ink layer only a few micrometers in thickness, and a transparent protective film must be further coated on the surface of the molded product to protect the thin layer of printed patterns against abrasion, scratch and color fading, lest the molded product should lose its aesthetic and quality appearance.

Moreover, since a relatively long time and a considerably high cost are needed for developing a new product and new decorative patterns therefor, the conventional technology of in-mold decoration by roller is not suitable for small batch production. In other words, the conventional technology of in-mold decoration by roller is only suitable for large batch production of products with less change in curvature thereof, such as the cases and keys for mobile phones, the cases for notebook computers and the like.

Another disadvantage of the conventional technology of in-mold decoration by roller is that the molded products must be manually cut from the cured plastic material in the runner after the mold is opened and the molded products are removed from the mold. This procedure increases the products' labor and manufacturing costs, which apparently does not satisfy the requirement for high-efficient and automated production in the modern society and makes the products less competitive in the market.

In view of the above-mentioned disadvantages, it is desirable to improve the conventional in-mold decoration technology by developing an apparatus and method for manufacturing product with decorative patterns in a simplified process, so as to increase the yield rate, the aesthetic appearance and the usability of the product at lowered manufacturing cost.

### SUMMARY OF THE INVENTION

A primary object of the present invention is to provide an apparatus for manufacturing product with decorative patterns, so that a plastic material injected into a mold can be molded along with a decorative film to form a molded product with decorative patterns, and the molded product is automatically cut from the cured plastic material in a runner of the mold when the mold is opened and the molded product is ejected from the mold, enabling largely increased production efficiency and yield rate of the product.

To achieve the above and other objects, the apparatus for manufacturing product with decorative patterns according to the present invention includes a fixed mold base, a movable mold base, and a decorative film. The fixed mold base has a fixed mold insert fitted therein, and the fixed mold insert is provided with a sprue and at least one molding cavity.

The movable mold base has a movable mold insert fitted therein and includes an ejector pin unit, and is selectively movable toward or away from the fixed mold base to enable mold closing or mold opening, respectively. The movable mold insert is provided with a runner communicable with the sprue, and at least one material receiving cavity communicable with the runner and corresponding to the at least molding cavity. The material receiving cavity has a modeling member fitted therein and a raised pressing frame formed therearound. A plurality of locating means is provided in between the fixed and the movable mold insert. The ejector pin unit includes a main ejector pin and at least one cutting ejector pin. The cutting ejector pin is located below and corresponding to the material receiving cavity, and is upward movable to a height beyond a point at where the material receiving cavity communicates with the runner; and the main ejector pin is upward movable to push against the runner.

The decorative film is sandwiched in between the fixed and the movable mold insert to cover the at least one molding cavity and the at least one material receiving cavity, and is provided with a material passing opening corresponding to the sprue and a plurality of locating holes corresponding to the locating means. According to an embodiment of the present invention, the decorative film includes a release layer, a cured layer, at least one ink layer and an adhesive layer, which are sequentially arranged from top to bottom. The release layer is provided for contacting with the fixed mold insert, and the adhesive layer for contacting with the movable mold insert.

Another object of the present invention is to provide a method for manufacturing product with decorative patterns, so as to simplify the process for forming a product with a decorated external surface and to reduce the manufacturing time, labor and material costs of the product, enabling the product to be more competitive in the market.

To achieve the above and other objects, the method for manufacturing product with decorative patterns according to the present invention includes the following steps:

separating a movable mold base from a fixed mold base, and placing a decorative film between the two mold bases;

closing the movable mold base to the fixed mold base, so as to sandwich the decorative film in between the two mold bases;

injecting a plastic material into the fixed mold base, so that the plastic material flows through a runner provided on the movable mold base into at least one material receiving cavity, which is also provided on the movable mold base;

allowing the plastic material to cure in the runner and the material receiving cavity to form a half-finished product with the decorative film attached thereto;

separating the movable mold base from the fixed mold base, and actuating an ejector pin unit fitted in the movable mold base to cut the half-finished product from the plastic material cured in the runner while pushing the half-finished product upward; and

removing the half-finished product from the movable mold base and peeling off a release layer of the decorative film, so as to obtain a finished product having decorative patterns shown on a surface thereof.

In a preferred embodiment, the ejector pin unit includes at least one cutting ejector pin and a main ejector pin. The cutting ejector pin functions to cut the half-finished product from the cured plastic material in the runner, and the main ejector pin functions to upward push against the whole cured plastic material. In addition, a plurality of locating means is further provided in between a fixed mold insert fitted in the fixed mold base and a movable mold insert fitted in the movable mold base, and the decorative film is provided with a plurality of locating holes corresponding to the locating means, so that the decorative film can be accurately placed in between the fixed and movable mold bases.

The present invention is characterized in forming the runner on the movable mold insert and placing the decorative film in between the fixed and the movable mold insert. In this manner, the decorative film is directly incorporated with the injected plastic material when the latter is molded in the mold, and the steps for manufacturing product with decorative patterns can be simplified. Further, the cutting ejector pin in the ejector pin unit automatically cuts the half-finished product from the cured plastic material in the runner when the ejector pin unit is upward moved to eject the half-finished product from the movable mold insert. Therefore, the step of manually cutting the half-finished product from the runner as needed in the conventional in-mold decoration technology is saved to effectively reduce the labor cost and increase the yield rate of the product. Moreover, since customized patterns can be produced on the decorative film, the product manufactured with the apparatus and the method of the present invention can have varied and abrasion-resistant surface patterns.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIGS. 1A to 1D illustrate the manufacturing process of a conventional technology of in-mold decoration by roller;

FIG. 2 is a vertical sectional view of an apparatus according to a preferred embodiment of the present invention for manufacturing product with decorative patterns, with a fixed and a movable mold base of the apparatus closed to each other;

FIG. 3 is a partially enlarged view of FIG. 2;

FIG. 4 is a bottom plan view of a fixed mold insert for the apparatus of the present invention;

FIG. 5 is a top plan view of a movable mold insert for the apparatus of the present invention;

FIG. 6 is a vertical sectional view of the movable mold insert of FIG. 5;

FIG. 7 is a vertical sectional view showing the fixed and the movable mold insert for the present invention when the fixed and movable mold bases are closed to each other;

FIG. 8A is a perspective view of a decorative film for the present invention;

FIG. 8B is a sectional view of the decorative film of FIG. 8A;

FIG. 9 is a flowchart showing the steps included in a method according to the present invention for manufacturing product with decorative patterns; and

FIGS. 10A to 10G pictorially illustrate the steps of the method according to the present invention.

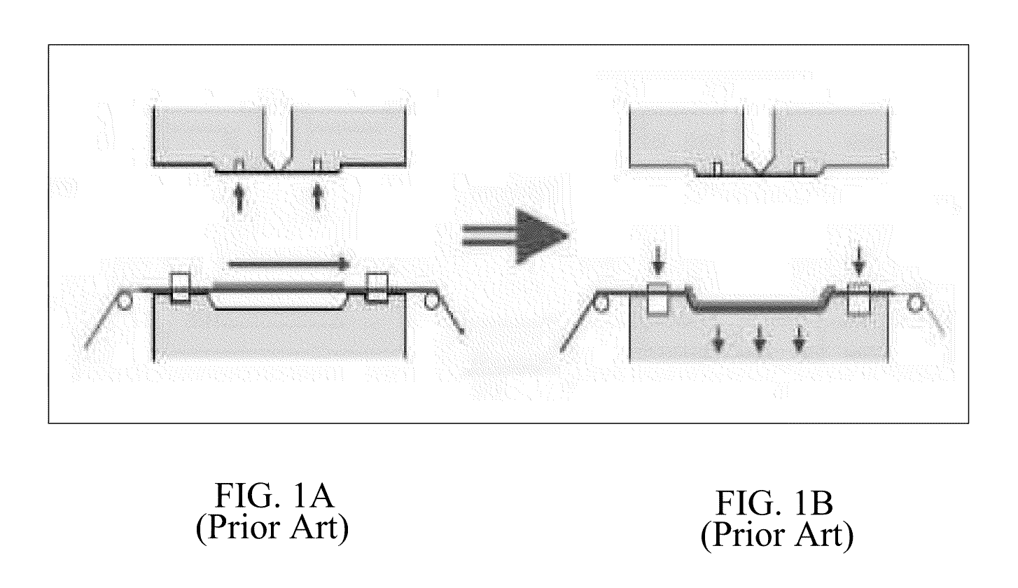

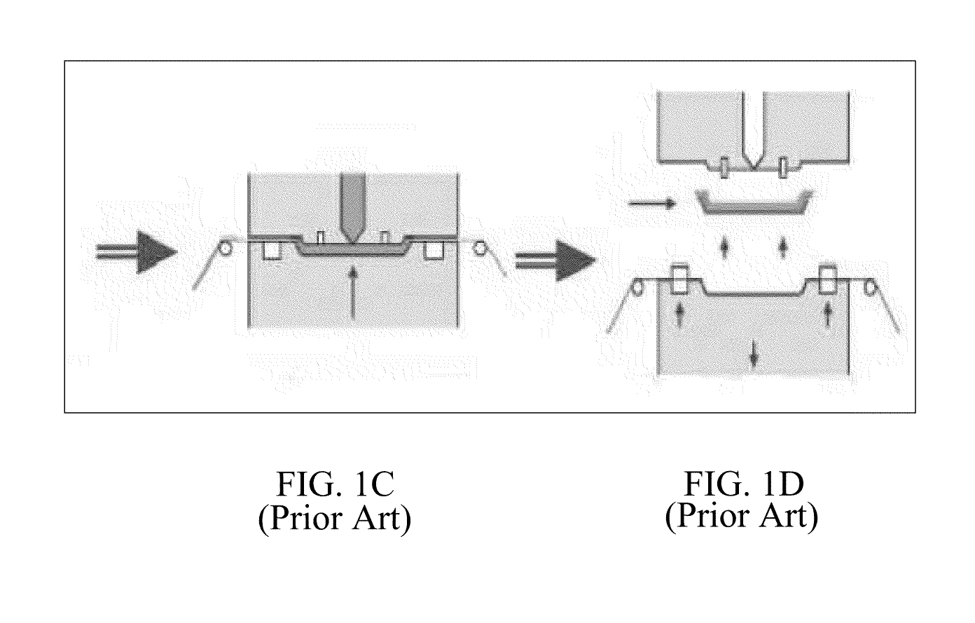

### DETAILED DESCRIPTION OF THE PREFERRED EMBODIMENTS

The present invention will now be described with a preferred embodiment thereof and with reference to the accompanying drawings.

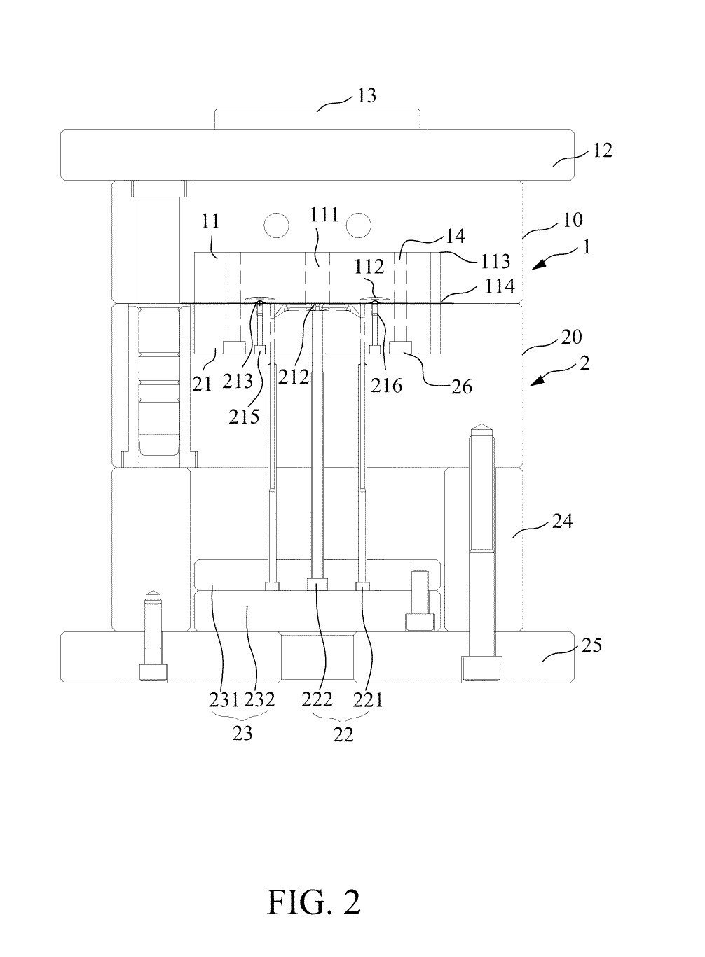

Please refer to FIG. 2. An apparatus according to a preferred embodiment of the present invention for manufacturing product with decorative patterns includes a fixed mold mechanism 1, a movable mold mechanism 2, and a decorative film 3. The fixed mold mechanism 1 includes a fixed mold base 10, a fixed mold insert 11 set in the fixed mold base 10, a top clamp plate 12, and a locating ring 13 provided on the top clamp plate 12.

The movable mold mechanism 2 includes a movable mold base 20, a movable mold insert 21 fitted in the movable mold base 20, an ejector-pin support plate assembly 23 centered in a space below the movable mold base 20 and consisting of two superposed plates, namely, an upper ejector-pin support plate 231 and a lower ejector-pin support plate 232, for supporting an ejector pin unit 22 thereon, two spacer blocks 24 separately located below two opposite lateral sides of the movable mold base 20 and each having a bottom flush with that of the lower ejector-pin support plate 232, and a bottom clamp plate 25 mounted to the bottoms of the spacer blocks 24 and the lower ejector-pin support plate 232.

The ejector pin unit 22 includes at least one cutting ejector pin 221 and a main ejector pin 222, all of which are pressed at their lower ends against a top of the lower ejector-pin support plate 232 and upward extended from a lower inner bottom of the upper ejector-pin support plate 231 through the movable mold base 20 into the movable mold insert 21.

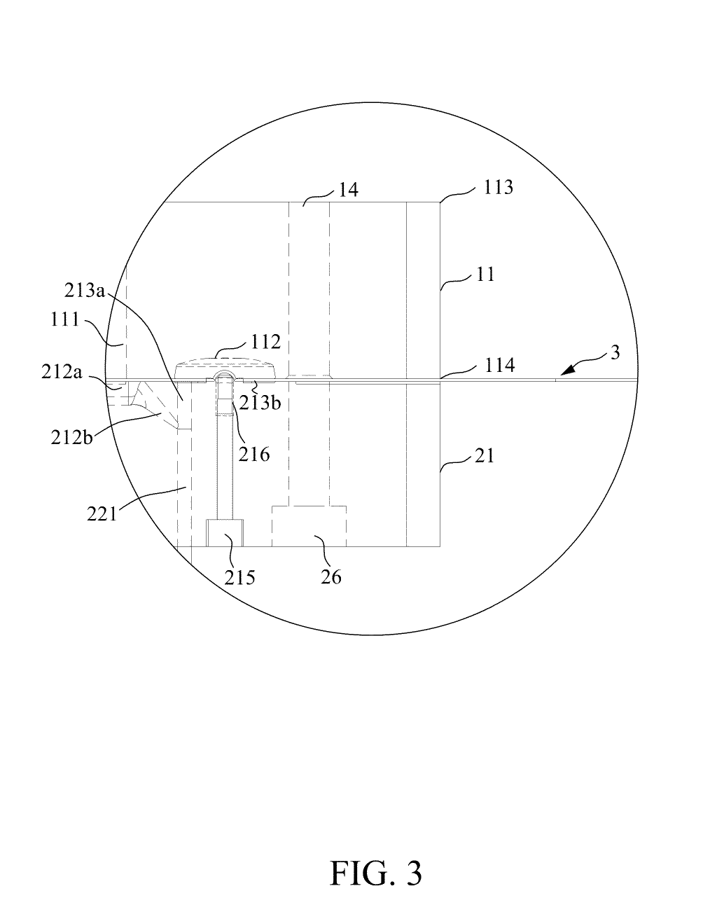

As can be seen in FIG. 3, which is a partially enlarged view of FIG. 2, the decorative film 3 is sandwiched between the fixed mold mechanism 1 and the movable mold mechanism 2, and is held in place by between two contact surfaces of the fixed mold insert 11 and the movable mold insert 21.

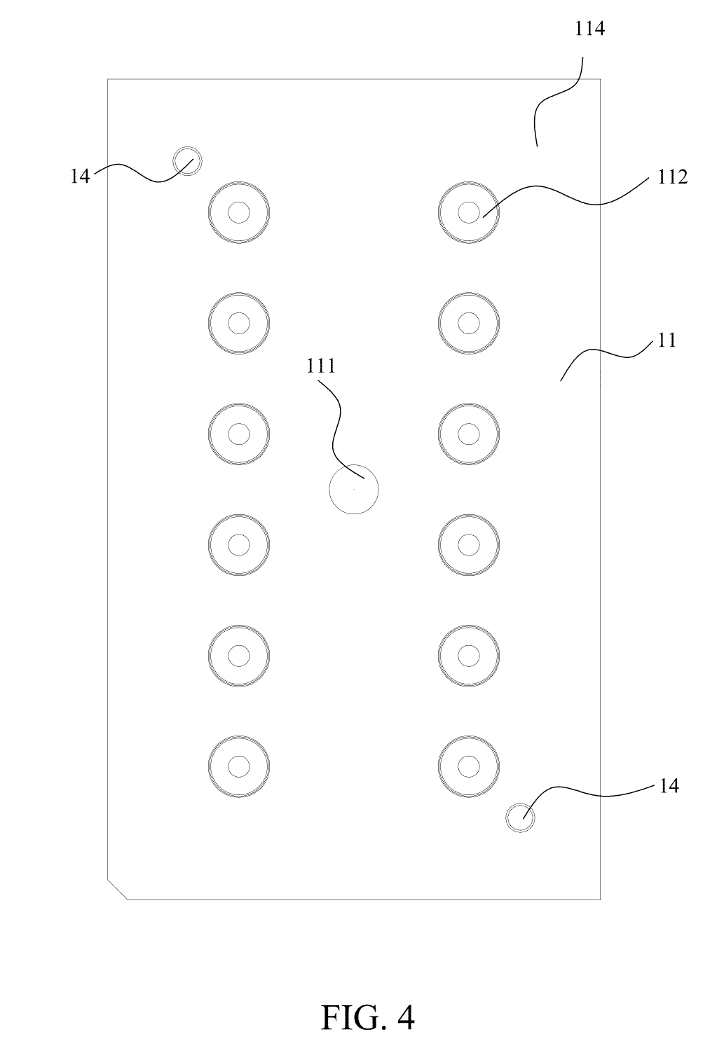

Please refer to FIGS. 2 and 4. On the fixed mold insert 11, there is formed of a sprue 111 and at least one molding cavity 112. The sprue 111 is centered on the fixed mold insert 11, and is extended from a material entrance side 113 to an opposite processing side 114 of the fixed mold insert 11. And, the molding cavity 112 is formed on the processing side 114.

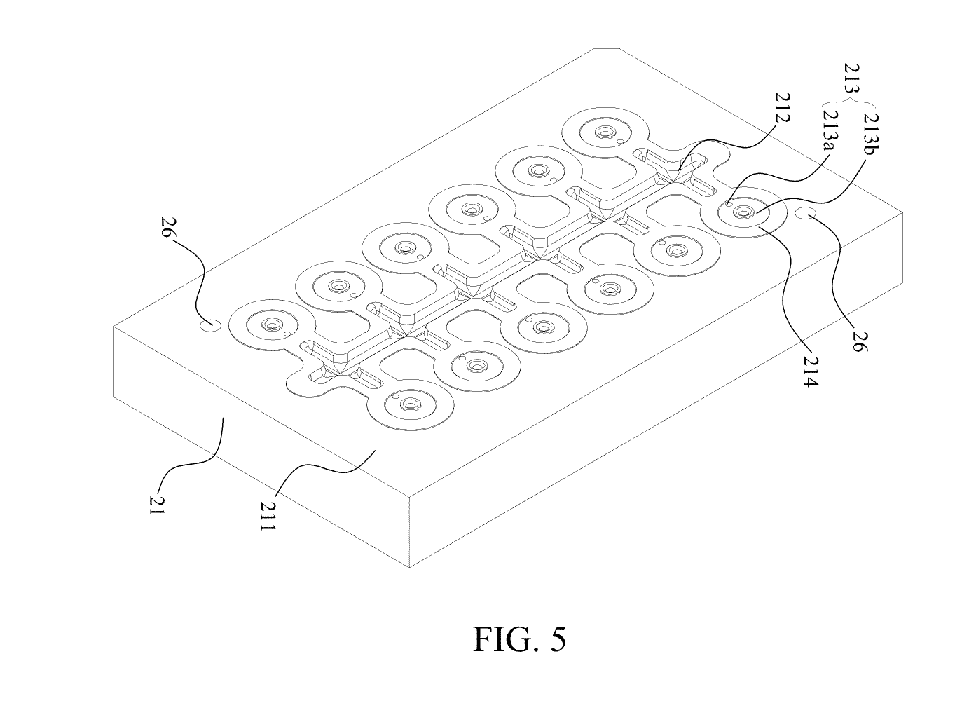

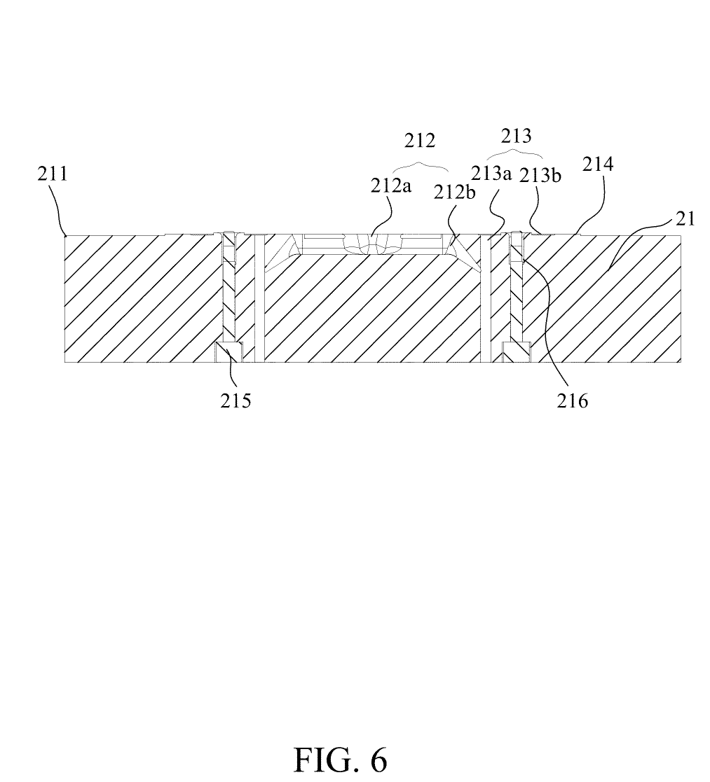

Please refer to FIGS. 5 and 6. The movable mold insert 21 has a processing side 211 for contacting with the fixed mold insert 11. On the processing side 211, a runner 212 and at least one material receiving cavity 213 are formed. The material receiving cavity 213 is corresponding to the molding cavity 112 in number and position. The runner 212 is communicable with the sprue 111 and the material receiving cavity 213. The material receiving cavity 213 has a raised pressing frame 214 formed therearound. When the fixed and the movable mold mechanism 1, 2 are closed to each other, the pressing frame 214 is pressed against the decorative film 3, preventing the decorative film 3 from getting wrinkles to adversely lower the yield rate of finished products.

The runner 212 includes a main runner portion 212a and a branch runner portion 212b. Further, the material receiving cavity 213 includes a first mold cavity 213a, which is communicable with the branch runner portion 212b, and a second mold cavity 213b, which is aligned with the corresponding molding cavity 112 and communicable with the first mold cavity 213a of the same material receiving cavity 213. As can be seen in FIGS. 2 and 3, the at least one cutting ejector pin 221 is brought to extend a length of its top portion into the first mold cavity 213a. It is noted the top portion of the cutting ejector pin 221 in the first mold cavity 213a is upwardly moved to a height beyond a point at where the branch runner portion 212b communicates with the first mold cavity 213a, such that cured plastic material connected to between the first mold cavity 213a and the branch runner portion 212b is cut open by the upward moved cutting ejector pin 221. And, as shown in FIG. 2, the main ejector pin 222 can be brought to press a top portion thereof against a bottom center of the runner 212 on the movable mold insert 21 for pushing and separating an integral body of the cured plastic material and the decorative film 3 out of the movable mold insert 21.

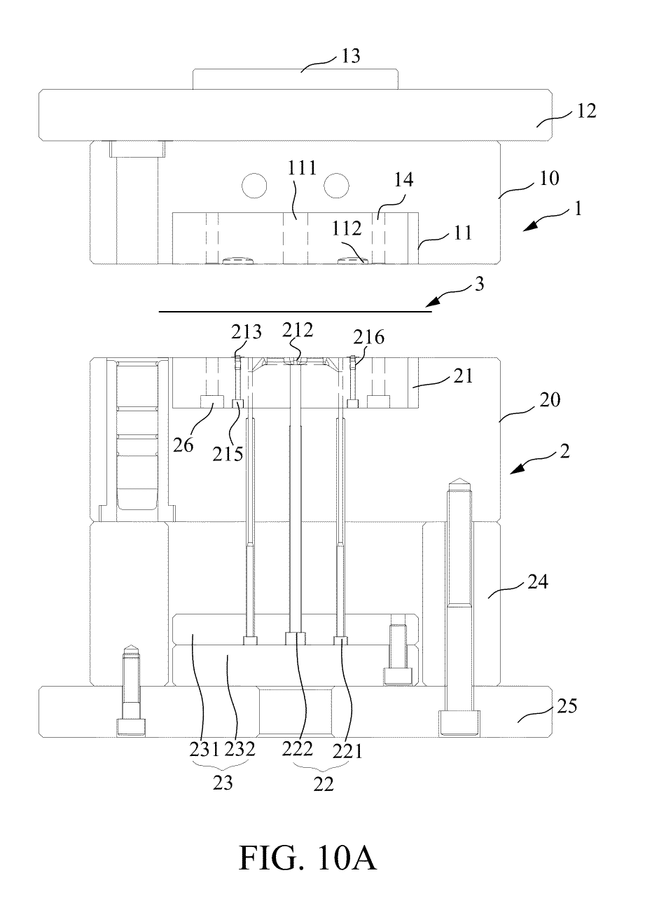

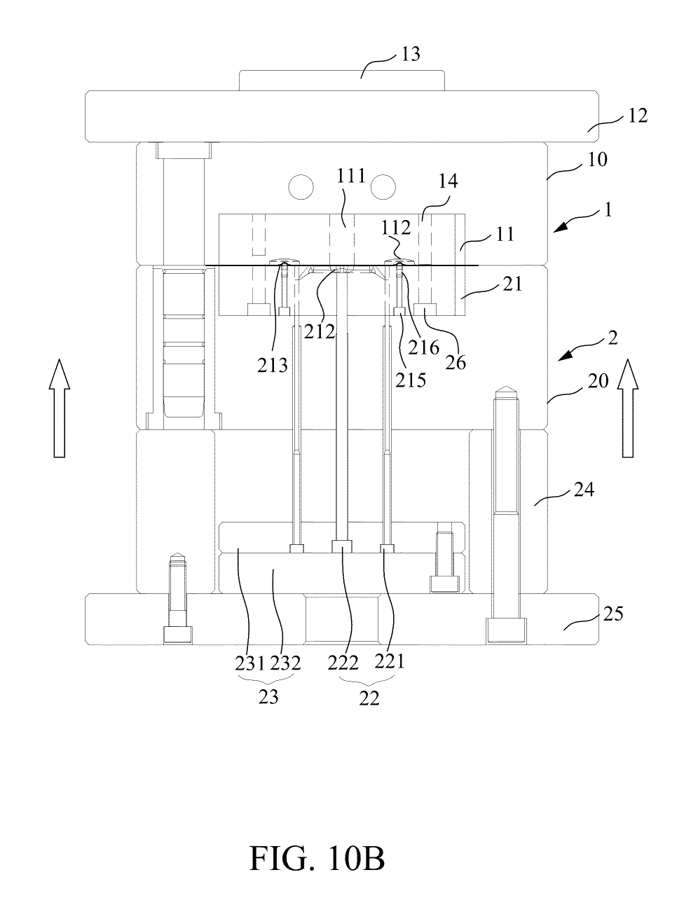

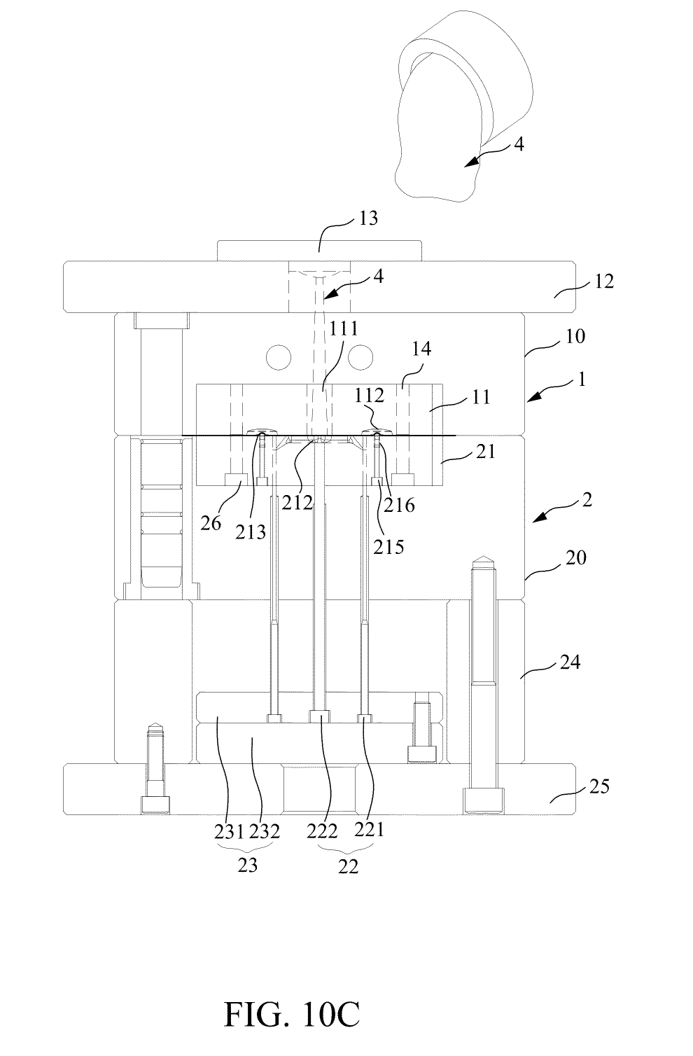

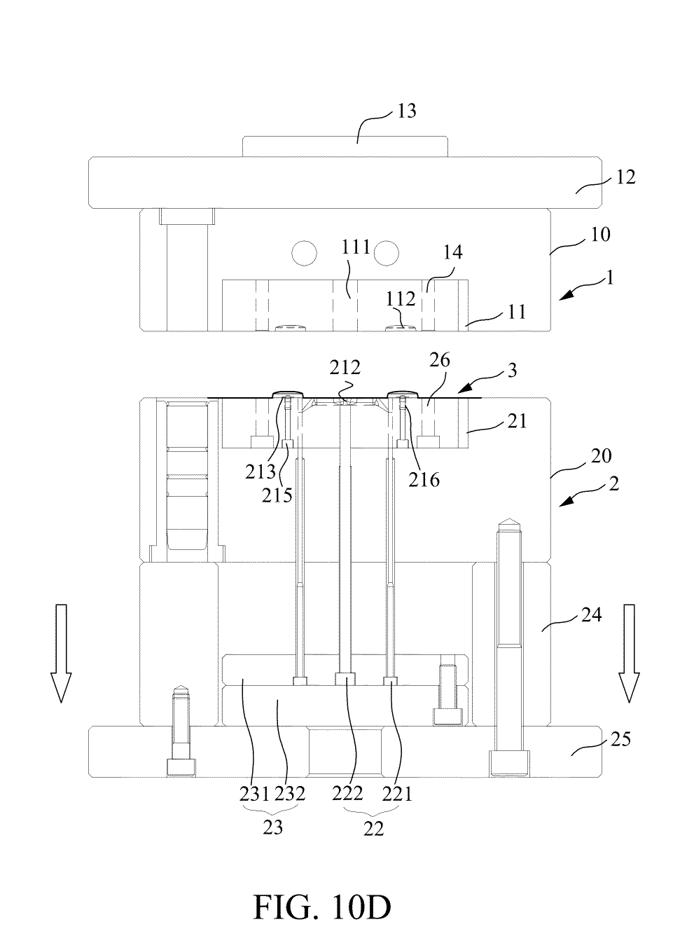

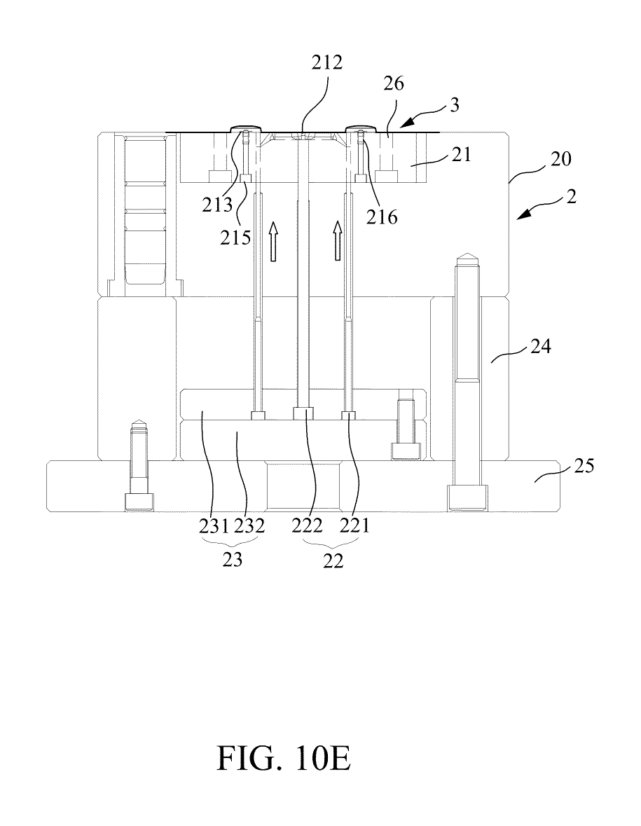

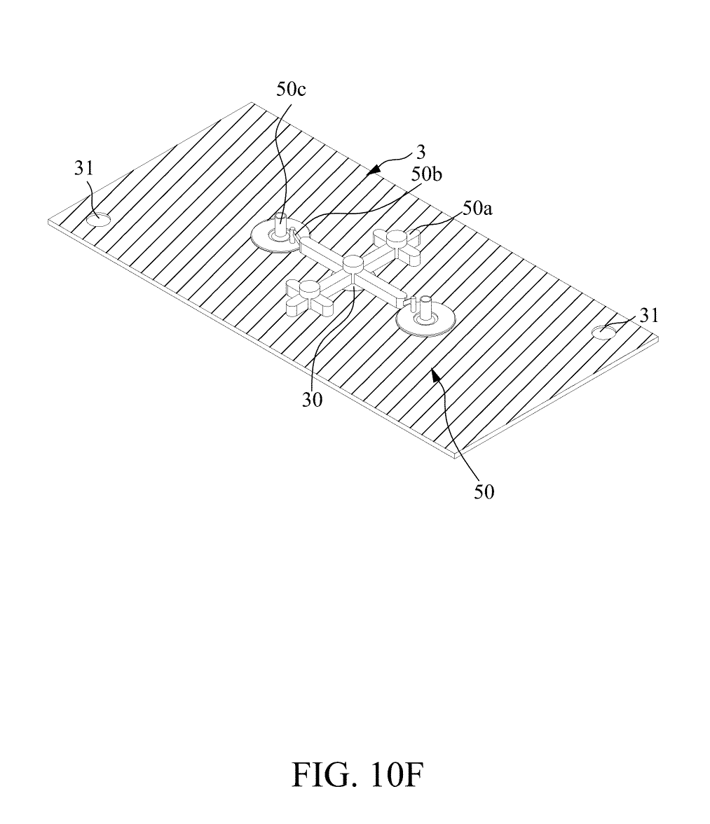

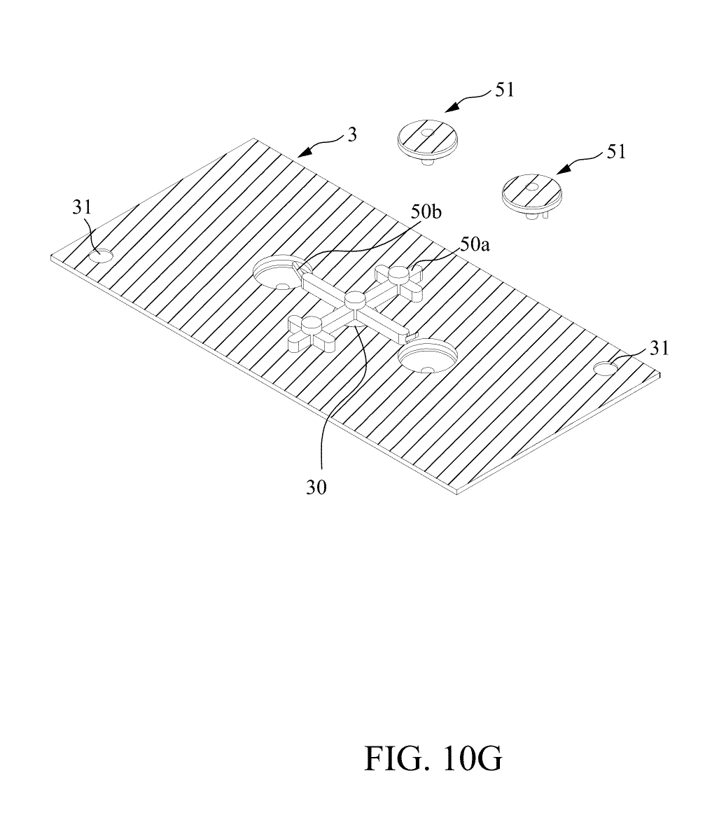

In the second mold cavity 213b, there is provided a modeling member 215 for changing an external shape of a finished product 51. In the illustrated preferred embodiment, the finished product 51 is a button, as shown in FIG. 10G, and the modeling member 215 is a rod, which is so sized that an annular space 216 is formed in the second mold cavity 213b around the rod 215, allowing the plastic material flowed into and molded in the annular space 216 to form a sleeve.

However, it is understood the finished product shaped into a button is only illustrative and not intended to limit the present invention in any way. It is also understood the modeling member 215 can be varied in configuration and in its position in the second mold cavity 213b to enable formation of finished products of different sizes and shapes.

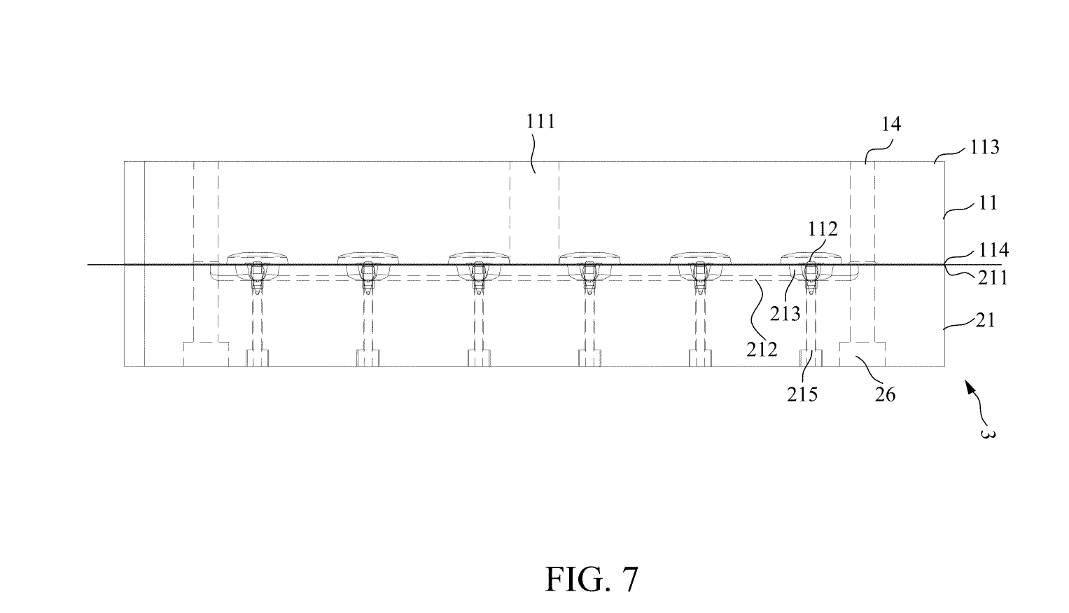

Please refer to FIG. 7. For the decorative film 3 to be precisely laid on the top of the movable mold insert 21, the fixed and the movable mold insert 11, 21 are provided at corresponding positions with internally threaded holes 14, 26, respectively, and a screw rod (not shown) can be screwed into each pair of two corresponding threaded holes 14, 26 to form a locating means. However, it is understood the locating means formed of the threaded holes and the screw rod are only illustrative and not intended to limit the present invention in any way.

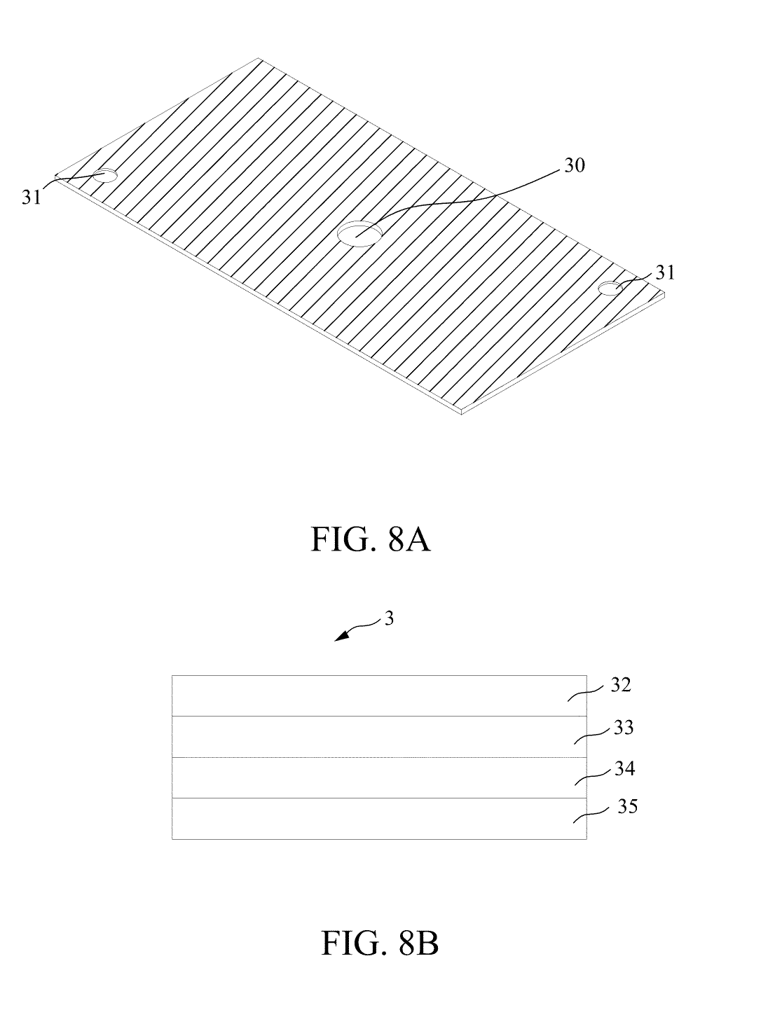

FIGS. 8A and 8B are perspective and sectional views, respectively, of the decorative film 3. As shown, the decorative film 3 is provided with a material passing opening 30 corresponding to the sprue 111 and a plurality of locating holes 31 corresponding to the locating means formed of the threaded holes 14, 26 and the screw rods. The decorative film 3 includes several layers sequentially arranged from top to bottom, namely, a release layer 32, a cured layer 33, at least one ink layer 34 and an adhesive layer 35. The release layer 32 is provided for contacting with the fixed mold insert 11, and the adhesive layer 35 for contacting with the movable mold insert 21. The release layer 32 can be easily peeled off from the decorative film attached to the surface of a half-finished product 50 as that shown in FIG. 10F. The cured layer 33 serves to protect the ink on the ink layer 34. And, the ink layer 34 can be manufactured to provide different decorative patterns according to individual users' requirement. The adhesive layer 35 is provided for contacting with the movable mold insert 21, so that the decorative film 3 is stably adhered to the movable mold insert 21.

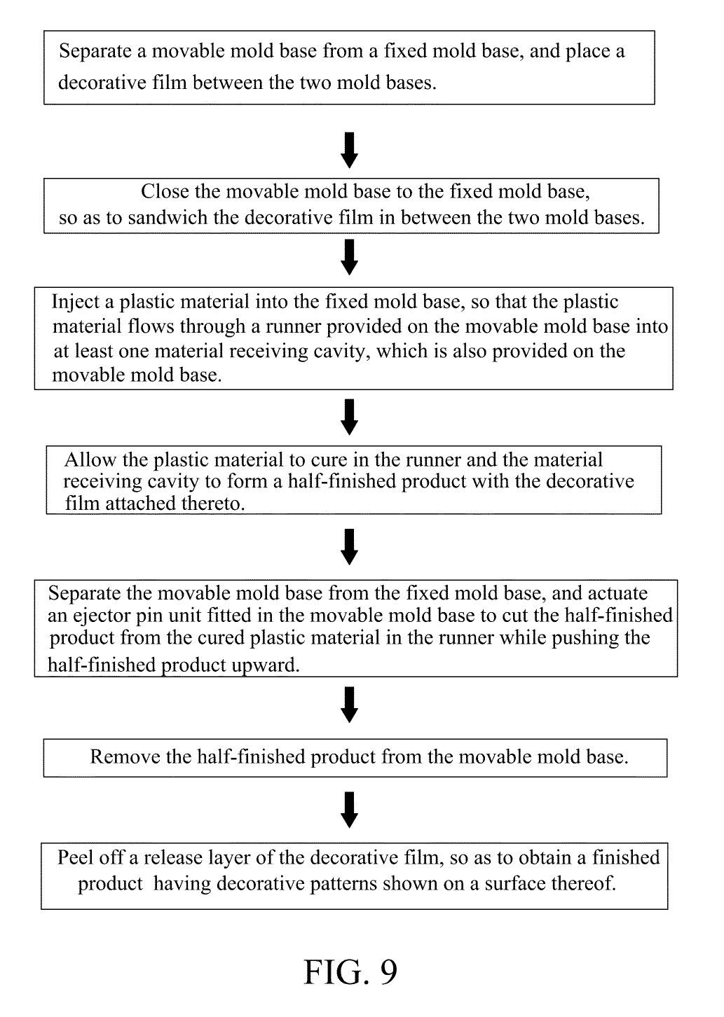

The present invention also provides a method for manufacturing product with decorative patterns, and FIG. 9 is a flowchart showing the steps included in the method of the present invention. The steps include:

separating a movable mold base from a fixed mold base, and placing a decorative film between the two mold bases;

closing the movable mold base to the fixed mold base, so as to sandwich the decorative film in between the two mold bases;

injecting a plastic material into the fixed mold base, so that the plastic material flows through a runner provided on the movable mold base into at least one material receiving cavity, which is also provided on the movable mold base;

allowing the plastic material to cure in the runner and the material receiving cavity to form a half-finished product with the decorative film attached thereto; and separating the movable mold base from the fixed mold base;

actuating an ejector pin unit fitted in the movable mold base to cut the half-finished product from the cured plastic material in the runner while pushing the half-finished product upward; and

removing the half-finished product from the movable mold base and peeling off a release layer of the decorative film, so as to obtain a finished product having decorative patterns shown on a surface thereof.

Please refer to FIGS. 10A to 10G that pictorially illustrate the steps of the method according to the present invention in more details. In FIG. 10, it is shown a sheet of decorative film 3 is placed between the fixed and the movable mold mechanism 1, 2 when the two mold mechanisms are separated from each other, so that the decorative film 3 is located on the top of the movable mold insert 21 with the material passing opening 30 formed on the decorative film 3 aligned with the sprue 111 formed on the fixed mold insert 11 and the runner 212 formed on the movable mold insert 21. In addition, the locating holes 31 formed on the decorative film 3 are correspondingly fitted around the locating means provided in between the fixed and the movable mold insert 11, 21.

In FIG. 10B, the movable mold mechanism 2 is moved upward to contact with the fixed mold base 10 and thereby sandwich the decorative film 3 in between the fixed and the movable mold insert 11, 21. Meanwhile, the locating means are tightened to close the movable mold base 20 to the fixed mold base 10.

In FIG. 10C, a plastic material 4 is injected into the runner 212 on the movable mold base 20 via the sprue 111 on the fixed mold base 10. Then, allow the plastic material 4 to flow through the runner 212 into the at least one material receiving cavity 213 on the movable mold insert 21 and the at least one molding cavity 112 on the fixed mold insert 11. When the plastic material 4 finally fills up all the spaces in the runner 212, the material receiving cavity 213 and the molding cavity 112, a half-finished product 50 can be formed.

In FIG. 10D, the half-finished product 50 is cooled and shaped, and the movable mold base 20 is separated from the fixed mold base 10 with the half-finished product 50 remaining on the movable mold insert 21.

In FIG. 10E, the ejector-pin support plate assembly 23 is actuated by a push force from a knockout structure of a molding machine (not shown), so as to move the ejector pin unit 22 upward. The cutting ejector pin 221 is aligned with the half-finished product 50 in the material receiving cavity 213 and function to cut the half-finished product 50 from the cured plastic material in the runner 212 while the main ejector pin 222 synchronously upwardly pushes against an integral body of the cured plastic material 4 in the runner 212, the material receiving cavity 213 and the molding cavity 112, so that the half-finished product 50 is pushed out of the movable mold base 20 to complete the ejection step.

In FIG. 10F, the half-finished product 50 along with the decorative film 3 attached thereto is removed from the movable mold insert 21. As can be seen in FIG. 10F, the half-finished product 50 includes three sections, namely, a main runner section 50a, a branch runner section 50b, and a molded body 50c. The main runner section 50a and the branch runner section 50b are shaped corresponding to the main runner portion 212a and the branch runner portion 212b of the runner 212, respectively. The molded body 50c has already been separated from the branch runner section 50b by the cutting ejector pin 221 in a previous step.

In FIG. 10G, the release layer 32 of the decorative film 3 is peeled off from the molded body 50c to obtain a finished product 51 having a decorative layer formed thereon. More specifically, the release layer 32 of the decorative film 3 can be easily peeled off from the half-finished product 50; and the finished product 51 is the molded body 50c of the half-finished product 50 with the release layer 32 removed therefrom to show the decorative patterns provided by the ink layer 34 of the decorative film 3.

The present invention has been described with a preferred embodiment thereof and it is understood that many changes and modifications in the described embodiment can be carried out without departing from the scope and the spirit of the invention that is intended to be limited only by the appended claims.

What is claimed is:

1. An apparatus for manufacturing product with decorative patterns, comprising:
a fixed mold base having a fixed mold insert fitted therein; and the fixed mold insert being provided with a sprue and at least one molding cavity;
a movable mold base having a movable mold insert fitted therein and including an ejector pin unit, and being selectively movable toward or away from the fixed mold base to enable mold closing or mold opening, respectively; the movable mold insert being provided with a runner and at least one material receiving cavity, the runner being communicable with the sprue on the fixed mold insert and the material receiving cavity, and the material receiving cavity being aligned and communicable with the molding cavity when the fixed and the movable mold base are closed to each other; and the ejector pin unit including at least one cutting ejector pin, which is located below and corresponding to the at least one material receiving cavity and is upward movable thereinto to a height beyond a point at where the material receiving cavity communicates with the runner; and
a decorative film for placement in between the fixed and the movable mold insert to cover the molding cavity and the material receiving cavity, and being provided with a material passing opening at a position corresponding to the sprue on the fixed mold insert.

2. The apparatus for manufacturing product with decorative patterns as claimed in claim 1, wherein the ejector pin unit further includes a main ejector pin, which is upward movable to push against the runner.

3. The apparatus for manufacturing product with decorative patterns as claimed in claim 1, wherein the movable mold base further includes a raised pressing frame located around the runner and the material receiving cavity.

4. The apparatus for manufacturing product with decorative patterns as claimed in claim 1, wherein the fixed mold insert and the movable mold insert are provided in between them with a plurality of locating means, and the decorative film is provided at positions corresponding to the locating means with a plurality of locating holes.

5. The apparatus for manufacturing product with decorative patterns as claimed in claim 1, wherein the material receiving cavity is internally provided with a modeling member.

6. The apparatus for manufacturing product with decorative patterns as claimed in claim 1, wherein the decorative film is formed of a release layer, a cured layer, at least one ink layer and an adhesive layer, which are sequentially arranged from top to bottom; and the release layer being provided for contacting with the fixed mold insert while the adhesive layer being provided for contacting with the movable mold insert.

7. A method for manufacturing product with decorative patterns, comprising the steps of:
separating a movable mold base from a fixed mold base, and placing a decorative film between the movable and the fixed mold base;
closing the movable mold base to the fixed mold base to sandwich the decorative film in between the two mold bases;
injecting a plastic material into the fixed mold base, so that the plastic material flows through a runner provided on the movable mold base into at least one material receiving cavity, which is also provided on the movable mold base;
allowing the plastic material to cure in the runner and the material receiving cavity to form a half-finished product with the decorative film attached thereto; and
separating the movable mold base from the fixed mold base, and actuating an ejector pin unit fitted in the movable mold base to cut the half-finished product from the cured plastic material in the runner while pushing the half-finished product upward.

8. The method for manufacturing product with decorative patterns as claimed in claim 7, further comprising the step of removing the half-finished product from the movable mold base and peeling off a release layer of the decorative film, so as to obtain a finished product having decorative patterns shown on a surface thereof.

9. The method for manufacturing product with decorative patterns as claimed in claim 7, wherein the ejector pin unit includes at least one cutting ejector pin and a main ejector pin, the cutting ejector pin functioning to cut the half-finished product from the cured plastic material in the runner, and the main ejector pin functioning to upward push an integral body of the cured plastic material out of the movable mold base.

10. The method for manufacturing product with decorative patterns as claimed in claim 7, wherein the fixed mold base and the movable mold base have a fixed mold insert and a movable mold insert, respectively, fitted therein; the fixed mold insert and the movable mold insert being provided in between them with a plurality of locating means, and the decorative film being provided at positions corresponding to the locating means with a plurality of locating holes to enable precise placement of the decorative film between the fixed and the movable mold base.
